(19) United States
(12) Patent Application Publication
(10) Pub. No.: US 2015/0310545 A1
(43) Pub. Date: Oct. 29, 2015

(54) SYSTEM AND METHOD FOR PROGRESS ACCOUNT OPENING BY MEANS OF RISK-BASED CONTEXT ANALYSIS

(71) Applicant: C1 Bank, St. Petersburg, FL (US)

(72) Inventors: Marcio deOliveira, Sarasota, FL (US); Trevor Burgess, St. Petersburg, FL (US); Vasyl Borysovych Martyniuk, St. Petersburg, FL (US)

(73) Assignee: C1 Bank, St. Petersburg, FL (US)

(21) Appl. No.: 14/265,115

(22) Filed: Apr. 29, 2014

(51) Int. Cl. G06Q 40/02

(52) U.S. Cl. CPC G06Q 40/02

(57) ABSTRACT

Systems and methods permit flexible and convenient customer account opening to minimize both customer friction and the risk to financial service providers. In one embodiment, a computing device associated with a financial service provider receives an account application containing customer information and a request to open a new account or a request to upgrade an existing account. The computing device performs a verification analysis to validate inputs, authenticate customer identity, ensure compliance with regulatory requirements, or evaluate the risk posed by a customer. The computing device performs a recommendation analysis to determine the appropriate product types and account restrictions that should be offered to a customer, if any. The computing device creates an account application status message indicating approval or denial of the account application.

### TECHNICAL FIELD AND BACKGROUND

The present invention relates generally to the field of account services, and more particularly, to systems and methods for progressive opening of financial accounts using risk-based context analysis. The systems and methods disclosed herein permit flexible and convenient customer account opening to minimize both customer friction and the risk to financial service providers.

The opening of an account is a critical juncture in the relationship between a customer and a financial service provider for both new and existing customers. Modern computing technologies and the availability of Internet-enabled devices have changed customer expectations with respect to the amount of time it takes to open an account and for account functions to become available to customers. The growing use of the Internet and online services has also created a demand for services that allow customers to open accounts remotely without having to visit a financial service provider's branches or retail locations. In response, financial service providers have created a number of services that permit customers to open accounts quickly and remotely either online or through kiosks, such as Automatic Teller Machines (“ATMs”).

These new technologies and increased customer expectations present a greater risk to financial service providers. When opening a new account, financial service providers must have sufficient information (e.g., government-issued photo identification, employment verification, etc.) to verify the customer's identity and to evaluate the financial and security risk posed by the customer. If the customer does not have this information readily available, the customer may become frustrated and turn to another financial service provider or abandon the idea of opening a new account altogether. And even if a customer does have this information readily available, a customer who is opening an account remotely might not have a convenient means of providing the information to the financial service provider. It would, therefore, be advantageous to provide systems and methods that permit quick and convenient account opening to reduce customer acquisition friction while limiting the risk financial service providers.

Accordingly, it is an object of the present invention to provide systems and methods that permit flexible, convenient, and prompt account opening while still minimizing the risk to service providers. The inventive systems and methods disclosed herein utilize risk-based context analysis to enable financial service providers to reasonably verify the identity of each customer during the account opening process. The systems analyze data collected from multiple sources, including customer inputs, customer computing devices, financial service provider kiosks, and public records, among other sources. Accounts can be opened using complete or partial data. The systems verify the customer's identity, quantify the risk level, and recommend products and accounts suited to each particular customer as well as account restrictions.

It is another object of the present invention to provide systems and methods that allow progressive account opening such that if a further analysis of customer information subsequent to an account opening reveals that a customer presents less of a risk, the customer is permitted to upgrade to an account with higher risk features. The systems and methods allow a provider to continually monitoring accounts and to make recommendations to change account types or restrictions.

### SUMMARY

According to one embodiment of the invention, a system and method of processing an account application is provided. The method includes receiving by a computing device associated with a provider, an account application containing customer information and a request to open a new account or a request to upgrade an existing account. The provider computing device performs a verification analysis and a recommendation analysis before generating an application status message indicating an approval or disapproval of the account application.

In another aspect of the invention, the account application is transmitted to the provider computing device by either a computing device associated with a customer or a provider terminal computing device. The application status message indicating approval or disapproval of the account application is transmitted to the customer computing device or the provider terminal.

In other aspects of the invention, the verification analysis includes screening the customer information against a database of individuals or entities known to present an increased risk to the provider. A further aspect of the invention includes performing as part of the verification analysis, an account ownership verification analysis, a historical account analysis, or a due diligence analysis.

According to another embodiment of the invention, a system and method of processing an account application includes monitoring, by the provider computing device, customer account activity data associated with a customer account. The provider computing device performs a historical account analysis utilizing customer account activity data and creates an account application containing a request to upgrade or demote a customer account. The account application is stored to a database in the provider computing device. The provider computing device also performs a recommendation analysis and generates an account application status message indicating an approval or disapproval of the account application. In a further aspect of this embodiment, the provider computing device also performs a verification analysis.

### BRIEF DESCRIPTION OF THE DRAWINGS

Features, aspects, and advantages of the present invention are better understood when the following detailed description of the invention is read with reference to the accompanying figures, in which:

FIG. 1 is a diagram of an account opening system according to one embodiment of the invention;

FIG. 2 is an exemplary data flow diagram according to one embodiment of the invention;

FIG. 3 is a schematic illustrating various channels for opening an account;

FIG. 4 is an flow chart illustrating a progressive account opening according to one embodiment of the invention; and

FIG. 5 is a flow chart illustrating the denial of an account upgrade request.

### DETAILED DESCRIPTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete and will fully convey the scope of the invention and enable one of ordinary skill in the art to make, use, and practice the invention.

Disclosed herein are systems and methods for progressive account opening that utilize risk-based context analysis combined with an optimum amount of data to enable a financial service provider (“FPS”) to form a reasonable belief that it knows the true identity of a customer and to evaluate the financial and security risks posed by a customer. Although the inventive systems and methods disclosed herein find particular application in opening financial accounts, one of ordinary skill in the art will recognize that the systems and methods apply generally to opening different types of accounts, such as accounts for online merchants or identity management services, like social media accounts or employer accounts.

When opening an account, a customer provides complete or partial information. Customer information is also gathered from other sources, including, but not limited to, a computing device operated by the customer, financial service provider terminals or kiosks, public records, and third party fraud-detection or credit-reporting services. The amount and type of customer information required to open an account depends on a variety of factors, including the nature and identity of the customer, the type of account and features requested by the customer, regulatory requirements, or the context of the new account application (e.g., the device being utilized or the customer's location).

After receiving the customer information, the system validates the customer information, authenticates the customer's identity, verifies regulatory compliance, and/or quantifies the customer's risk level. Based on the results of these analyses, the system recommends an account type as well as appropriate account restrictions or denies the new account request. After the account is opened, the system monitors the account and makes recommendations on whether or not to offer additional products, lift account restrictions, or impose additional restrictions based on historical transactions and patterns. The customer also has the option to submit requests for additional products or to lift account restrictions.

After receiving or making a request for additional products or to change account restrictions, the system may receive additional customer information directly from the customer or from third party sources. This information is used to perform further customer verification or risk-assessment analyses, and the results of these analyses are used to make recommendations about whether or not to approve or deny the request for new products or to change account restrictions. In this manner, customers are able to open new accounts while the provider is able to maintain an acceptable risk profile by withholding higher risk products and account features pending the completion of additional verification or risk assessment analyses.

As used herein, the term FSP generally describes the person or entity providing financial account services. The term FSP is used interchangeably with the terms provider, bank, or financial institution. The term account generally denotes a business arrangement providing for regular dealings between the provider and customer. The term account is used interchangeably with the terms product or service. The term customer is intended to generally describe an individual or entity that utilizes an account or purchases products and services from a provider. The term customer may be used interchangeably with the terms consumer, client, user, or applicant. The term associate is used interchangeably with the term representative and generally describes an individual employed by or associated with a provider and who provides service to customers.

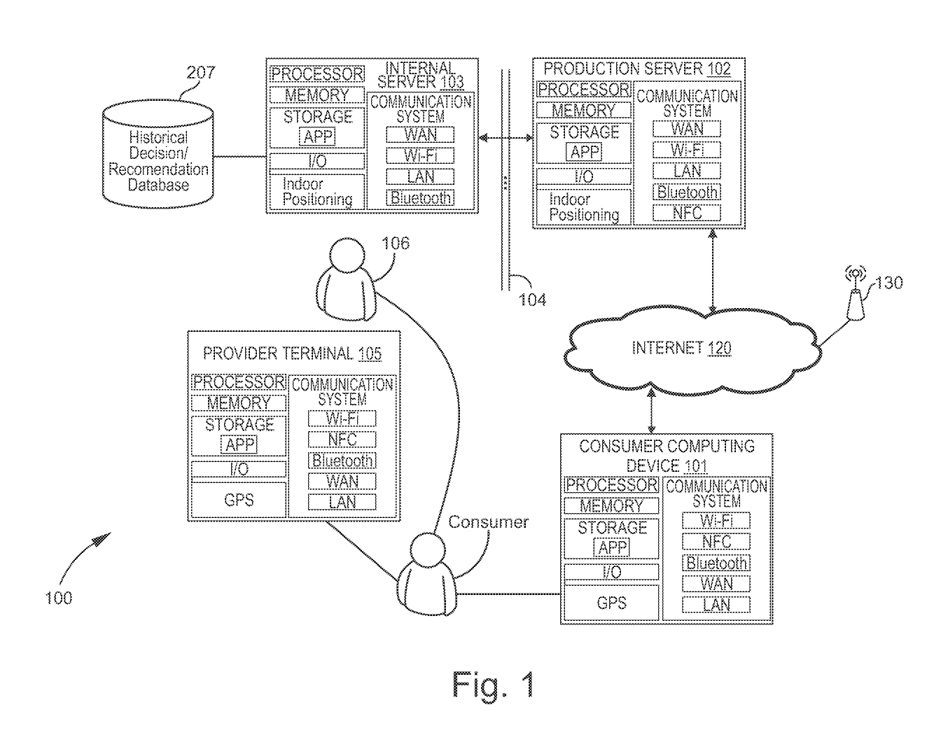

As shown in FIG. 1, a hardware system configuration according to one embodiment of the present invention generally includes a computing device 101 (e.g., an Internet-enabled device) operated by a consumer and a computer system associated with a provider 100. The provider's computer system 100 includes a production server 102, an internal server 103, a firewall 104, one or more provider terminals 105, and one or more computing devices (not shown) operated by the provider associates 106.

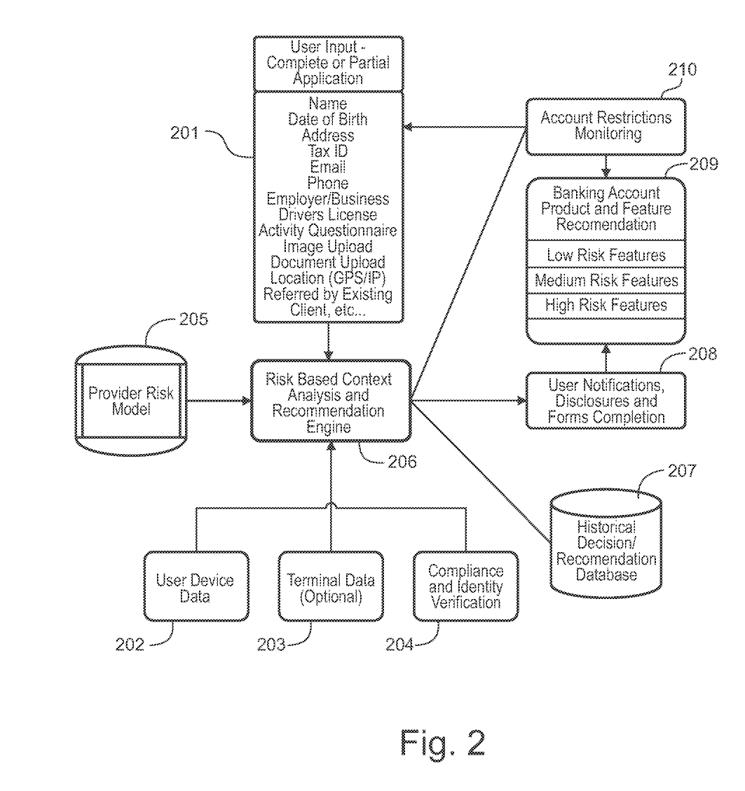

A functional configuration according to one embodiment of the invention is illustrated in FIG. 2 and depicts data flow between various modules used to implement the invention, including modules for: compliance and identity verification 204 (“verification analysis”); a provider risk model 205; a risk-based context and analysis recommendation engine 206 (“recommendation engine”); an account restrictions and monitoring engine 210 (“monitoring engine”); user notifications, disclosures, and forms completion 208 (“notice module”); and a historical decision and recommendation database 207.

The embodiments shown in FIGS. 1-2 are not intended to be limiting, and one of ordinary skill in the art will recognize that the system and methods of the present invention may be implemented using other suitable hardware or software configurations. For example, the system 100 may utilize only a single server implemented by one or more computing devices or a single computing device may implement one or more of the production server 102, internal server 103, firewall 104, one or more provider terminals 105, and/or associate computing devices. Further, a single computing device may implement more than one step or module 204-210, or a single step or module 204-210 may be implemented by more than one computing device.

The provider's computer system 100 may also include an indoor positioning system to gather information on the indoor location of a customer for use in the context analysis, as described in more detail below. The indoor positioning system can be implemented using any suitable wireless communication system configured to communicate through radio frequency (“RF”), WI-FI (e.g., wireless local area network products based on the Institute of Electrical and Electronics Engineers 802.11 standards), near field communications (“NFC”), BLUETOOTH®, or BLUETOOTH Low Energy (“BLE”). The indoor positioning system receives a wireless signal from a consumer computing device 101 and determines its location using radiolocation techniques such as, for example, the time difference of arrival (“TDOA”) method, the angle of arrival (“AOA”) method, the received signal strength indicator (“RSSI”) method, the link quality (“LQ”) method, or signature-based location methods.

In a preferred embodiment, the consumer computing device 101 is a portable electronic device that includes an integrated software application configured to operate as a user interface and to provide two-way communication with the provider's computer system 100. The portable electronic device can be any suitable type of electronic device, including, but not limited to, a cellular phone, a tablet computer, or a personal data assistant. As another example, the portable electronic device can be a larger device, such as a laptop computer. The portable electronic device can include a screen and one or more buttons, among other features. The screen can be a touch screen that includes a tactile interface.

Any suitable computing device can be used to implement the consumer computing device 101 or the components of the provider's computer system 100. The consumer computing device 101, the provider's servers 102-103, the firewall 104, the provider terminal 105, and the associate computing devices may include a processor that communicates with a number of peripheral subsystems via a bus subsystem. These peripheral subsystems may include a storage subsystem, user-interface input devices, user-interface output devices, a communication system, a network interface subsystem, and a Global Positioning System (“GPS”). By processing instructions stored on one or more storage devices, the processor may perform the steps of the present method. Any type of storage device may be used, including an optical storage device, a magnetic storage device, or a solid-state storage device.

Typically, the consumer computing device 101 accesses the provider's computer system 100 over the Internet 120 in the normal manner—e.g., through one or more remote connections, such as a Wireless Wide Area Network (“WWAN”) 130 based on 802.11 standards or a data connection provided through a cellular service provider. These remote connections are merely representative of a multitude of connections that can be made to the Internet 120 for accessing the provider's computer system 100.

It should be understood by those skilled in the art that although the present disclosure refers generally to GPS devices, the term GPS is being used expansively to include any satellite-based navigation system, such as the Galileo system, the GLONASS system, or the BeiDou Satellite Navigation System. Furthermore, references to GPS include both Assisted GPS and Aided GPS devices. Those skilled in the art will also recognize that other types of positioning systems can be used to implement the present invention, including, for example, radiolocation systems using the TDOA method, the AOA method, or signature-based location methods.

As illustrated in FIGS. 1 & 3, a customer has the option open an account through a variety of channels. By way of example, a customer is able to open an account using a consumer computing device 101 to access the provider's computer system 100 through a provider website or the website of a provider affiliate. A customer can also open an account through a provider terminal 105, or the customer can engage a provider associate 106 by telephone or in person at a provider retail location.

Regardless of how the customer opens the account, the system prompts the customer or associate 106 using a series of questions or data fields to enter some or all of the information required to open an account, including customer biographical information and information concerning the type of account and account options requested by the customer. The information required to open an account varies according to a number of factors, such as the identity and characteristics of the customer, the type of account requested, the restrictions on the account, regulatory requirements, or the context of the account opening, among other factors. Examples of required customer information can include: the customer's first and last name; tax identification number (e.g., social security number or employer identification number); mailing address; telephone number; facsimile number; date of birth; and email address.

A customer can also be asked to provide certain documents, such as government issued identification (e.g., a driver's license or passport) or business validation documents, like certified articles of incorporation and business licenses. In one embodiment, customers are asked to complete an activity questionnaire to provide details about the nature and frequency of expected use for the account as well as information about the customer's historical activities. Activity information can include, for instance, whether the customer intends to make a certain number of withdraws per month or whether the customer intends to utilize personal checks. Historical activity information can include a customer's memberships and affiliations, whether the customer was referred by another customer or provider affiliate, and for business clients, the type of business entity or the nature of the business.

The customer specifies one or more funding sources for the account. Funding sources may include checks, cash deposits, an electronic funds transfer from an external account, credit card or debit card accounts, or a preexisting account with the same provider. Funding can be accomplished using a combination of sources or multiple transfers from one or more sources over a period of time.

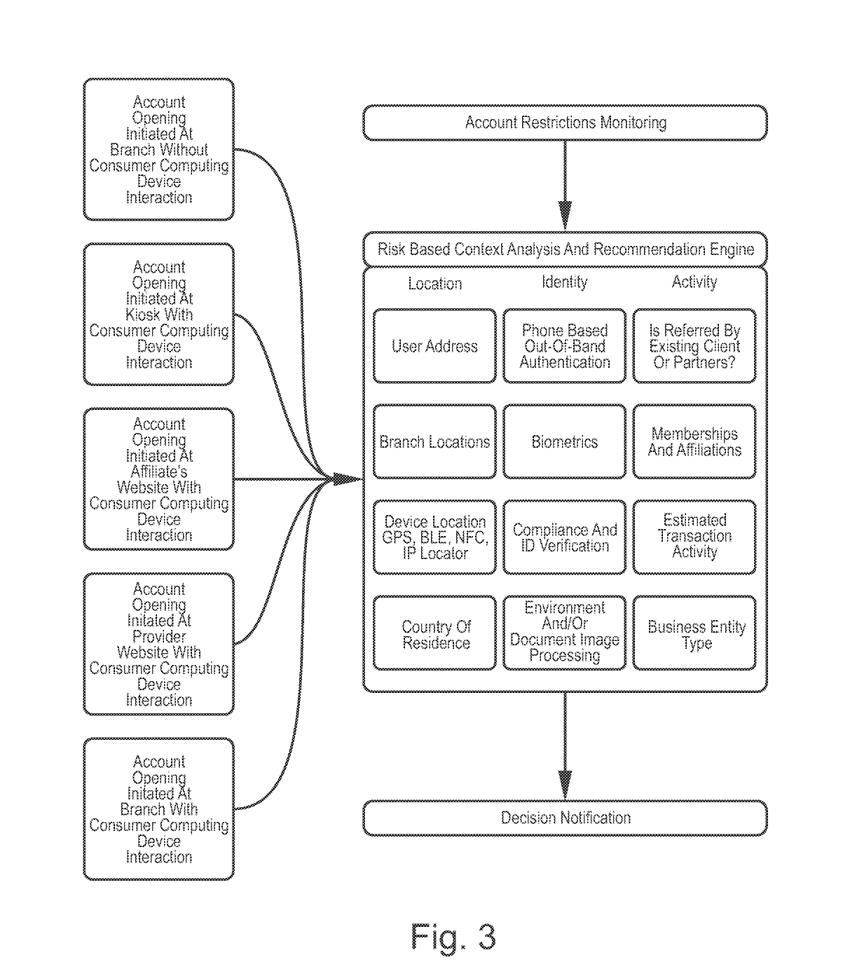

Besides requesting information directly from the customer, the system also obtains information from a variety of other sources, including the consumer computing device 101, a provider terminal 105, affiliate websites, public records, third-party service providers, or a combination of such sources. Customer information can be gathered from multiple sources during the same transaction, as illustrated in FIG. 3. If, for instance, a customer opens an account through an affiliate's website using a consumer computing device 101, the customer can transmit relevant information stored on the consumer computing device 101 as well as biographical or historical account information stored in a database on the affiliate's computer system.

In one embodiment, the provider's computer system 100 or a provider terminal 105 automatically recognizes the consumer computing device 101 and establishes a connection through a BLUETOOTH low-energy link when the consumer computing device 101 is proximal to the provider computer system 100 or terminal 105, such as when a customer enters a provider branch or retail location. After a link is established, the provider's computer system 100 or the provider terminal 105 receives information from the customer and the consumer computing device 101. In another embodiment, the customer utilizes the consumer computing device 101 to access the provider's website for the purpose of opening an account, and information input by the customer is transmitted to the provider's computer system 100 along with information stored in a database of the consumer computing device 101.

Examples of useful customer information gathered from the consumer computing device 101 include: context information like geographic location data generated by an integrated GPS device; cancellable biometric information, like fingerprints or photographic images of the customer; or identity authentication information, such as token or cookie, generated during a prior login to the provider's computer system 100. Likewise, customer information gathered from a provider terminal 105 can include geographic location information as well as information concerning the customer's existing relationship and account history with the provider.

Some embodiments include additional security features that utilize information generated by the consumer computing device 101 or provider terminal 105 to perform context analysis checks. Context analysis examines the circumstances and activities of the customer to optimize the presentation and content of information and to improve security. To illustrate, a provider that is running a promotion at a particular location, such as a local park, can utilize information about the circumstance of the park location to verify the authenticity of a new account request. The provider can require customers requesting a new account in connection with the promotion to transmit to the provider's computer system 100 both geographic location information and a photographic image of the customer next to a known landmark at the park. The provider authenticates the new account request by comparing the received location information and photographic image to known information to verify that the new account request was initiated by the customer at the promotion location.

Turning again to FIG. 2, after customer information is received during a new account request, the system performs a verification analysis 204 to validate user inputs, verify the customer's identity, quantify the risk of fraud, and ensure compliance with state and federal regulations. To validate user inputs, the system can be configured to review customer information in real time as it is entered and to check the information against a predetermined set of rules. Useful rules include notifying the user or automatically editing certain data fields when information is entered in an incorrect format. An example of such a rule is that the system can be configured to notify the user if a zip code does not contain at least five digits or if a social security number does not contain nine digits. Other input validation techniques include matching the zip code to the city listed in the address information and checking the social security number against a database to ensure that the number is valid.

The verification analysis 204 also includes performing one or a combination of identity authenticity and fraud assessment techniques, such as: account ownership verification (“AOV”); identity verification (“IDV”); identity authorization (“IDA”); historical account analysis; United States Office of Foreign Asset Control (“OFAC”) screening; politically exposed person (“PEP”) screening; employment and income verification; image scanning and validation; customer due diligence (“CDD”); and enhanced customer due diligence (“EDD”). Verification analysis 204 is performed by the provider alone or in combination with third party agencies, like fraud-detection or credit agencies.

Verification analysis 204 utilizes information received from a multitude of sources, including information entered by a customer, information obtained from third-party agencies (e.g., credit bureaus and insurers), and information obtained from public records. Typical sources of public records include, but are not limited to: court files; state and federal tax records; property records; U.S. Social Security Administration Verification Services; the Death Master File published by the U.S. Department of Commerce; and secretary of state filings from all fifty states. IDV techniques compare information obtained from third-party agencies and public records against information received from the customer, and inconsistencies in the data sets represent possible indicia of fraud or mistaken identity, which is relevant to assessing the customer risk level.

Funding sources specified by a customer are validated using AOV techniques. In one embodiment, the funding source is validated by sending a micropayment of a random amount to the funding source account and asking the customer to verify the amount of the deposit. In this manner, the provider determines in substantially real time whether the funding source account exists, whether the account is in good standing, and whether the customer has rights to the account.

IDA techniques present the customer with a series of questions about the customer's personal background that only the customer would know based on information obtained from third-party agencies or public records. As an example, a multiple choice question is generated using former addresses listed on a customer's credit report. The answer choices to the question include one former address and four randomly chosen addresses. The question is presented to the customer, and selection of the correct answer is a positive indicator that the customer's identity is authentic.

OFAC and PEP screening checks customer information against public or private databases of individuals known to present an increased risk to the provider or who are precluded by law from engaging in certain financial transactions. In the case of OFAC screening, the customer information is compared against a specially designated national list (“SDN list”) maintained by the U.S. OFAC of groups and individuals who are deemed to present a threat to national security and foreign or economic policy, such as terrorists, money launders, organized crime affiliates, and narcotics traffickers. Politically exposed persons are individuals entrusted with a prominent public function and who are presumed to be at a higher risk for involvement in bribery and corruption as a result of their position and influence.

The OFAC SDN List entries and PEP database entries typically contain a full name, address, nationality, passport, tax identification number, place of birth, date of birth, and former names and aliases, and other relevant information. The SDN List and PEP databases are searched using matching and scoring techniques that reduce the occurrence of false positive matches and that provide an instant pass/fail response. If for instance, a customer's name matches a name on the U.S. OFAC's SDN list, the customer's current and former addresses, tax identification number, or other information is compared against information in the SDN List entry to determine whether or not the match is a false positive. Similarly, PEP screening checks customer information against databases of known heightened-risk individuals and businesses, such databases maintained by WorldCompliance®, a LexisNexis® affiliate.

Verification analysis 204 optionally incorporates employment and income verification. Current and previous employers are verified by contacting the employers to request verification or by comparing the employment history provided by a customer against the customer's tax records. Tax records are also used to verify a customer's reported income.

Other verification analysis 204 techniques include reviewing documents, such as government-issued identifications or personal checks, or reviewing scanned images of such documents to ensure that the proper security features are present, such as holograms or watermarks printed on driver's licenses, passports, and personal checks.

Nondocumentary verification analysis 204 techniques include verifying a customer's phone number or email by contacting the customer. One exemplary technique is to send the customer an email containing hyperlink that takes the customer to a webpage where the customer confirms receipt of the email. This provides some assurance that the email account exists and that the customer has rights to the account.

Historical account analysis considers both positive and negative account information predictive of customer risk. For instance, a large average account balance is a positive indicator that the customer does not pose a high risk while multiple instances of overdraft or not sufficient funds (“NSF”) withdraws indicates a higher risk. Those skilled in the art will appreciate that numerous factors bear on the risk level posed by a customer, and the exemplary factors discussed herein are not intended to be limiting.

Risk factors considered as part of a historical analysis may be incorporated into a model that uses a set of logical rules to evaluate customer risk or considered as part of a quantitative risk assessment procedure. The implementation of a rule based historical account analysis model can be better understood with reference to the following simplified example that uses a series of binary inquiries to classify the customer as high, moderate, or low risk. Exemplary inquiries ask whether: (1) the account balance has been maintained above a certain dollar threshold for a specified period of time (e.g., above $5,000 for over six months); (2) there has been no NSF withdraws for a specified period; and (3) the customer has made a minimum number of deposits over a specified period (e.g., at least three deposits in three months).

If all of the inquiries are answered in the affirmative, the historical account analysis returns a pass result indicating that the customer might be classified as a low risk (provided that the other verification analysis 204 techniques return favorable results). On the other hand, if any of the inquiries are answered in the negative, the historical account analysis returns a fail result, and the customer might be classified as a high risk. Upon returning a fail result, the system can optionally prompt the provider to request additional information from the customer to assist in evaluating the customer risk. For instance, if the account balance inquiry returns a negative result, the system can prompt the provider to inquire whether the customer has a second financial account that maintains an adequate balance. At that point, the provider could reclassify the customer as low risk if such a second account existed, or the provider could suggest that the customer transfer funds from the second account to the account subject to the historical analysis.

Continuing with this example, the rule based model can be modified to require two negative answers before returning a fail or high risk result. Or a negative answer to one of the inquiries can return a result classifying the customer as a medium risk rather than a high risk to account for factors that are less predictive of risk. In other words, a provider might determine that instances of NSF withdraws correlate strongly to high risk customers but having a minimum number of deposits does not. Thus, the provider can incorporate a rule into the model requiring that a negative response to the number of deposits inquiry returns a result classifying the customer as a medium risk.

Quantitative historical analysis models can be implemented by assigning numeric scores to inquiry responses. The scores are added together, and an overall score that falls within a particular numeric range is translated to a corresponding risk level. In the example above, the presence of one or more NSF withdraws can be assigned a score of “10,” and a failure to meet the minimum balance requirement can be assigned a score of “5” to indicate that this factor is less predictive of customer risk. A customer with one NSF withdrawn and who did not meet the minimum balance requirement would have an overall score of “15.” If the provider's risk model 205 dictated that an overall score of 0-5 is low risk, a score of 5-10 is moderate risk, and a score of 10-15 is high risk, the customer in this scenario might be considered a high risk.

The quantitative historical analysis model could be further refined by modifying the inquires to permit a range of possible responses with a range of numeric scores assigned based on the responses. So, for example, an average account balance between $3,001 and $5,000 over a specified time could be assigned a score of “5,” and an average account balance between $5,001 and $7,000 could be assigned a score of “4” indicating a lower risk. A model structured in this fashion would permit more precise calculations of risk. However, one of skill in the art will recognize that any suitable model can be used, and the model can consider a wide range of potential factors that bear on customer risk.

Another possible embodiment of the invention incorporates customer due diligence techniques as part of the verification analysis 204. Customer due diligence can also be implemented as a series of inquiries directed to evaluating customer risk. For instance, a provider evaluating a new account request from a business customer can determine whether: the business site is local; the business has operated for at least two years; the business sends or receives international electronic funds transfers; the cash volume is appropriate for the business; the open account request is missing identification or other documents; and any other relevant information.

Each response is assigned a numeric score reflecting the risk posed by that factor. As an example, a response stating that the business has been operating less than two years is scored as a “5,” and a response stating that the business has been operating longer than two years is scored as a “1.” The responses to each inquiry can be scored the same (e.g., a “1” or a “5”), or the responses can be scored differently to reflect different weights assigned to each factor in determining customer risk. The scores for each response are summed to yield an overall score, and the customer is classified as a low, medium, or high risk based on whether the overall score falls within certain numeric ranges.

If the business customer falls within the medium or high risk category, the provider can further investigate the customer by performing an enhanced due diligence procedure. The enhanced due diligence procedure is a more detailed investigation whereby the provider contacts the customer in person or by phone to evaluate circumstances such as whether: the individual who initiated the account opening is available; the business answers telephone calls in a professional manner; the business is appropriately staffed; the nature of the business matches information provided in connection with the new account application; or any other relevant factor. Once again, the responses are assigned a numeric score reflecting the risk posed by that factor, and the scores are summed to yield an overall score that gives further insight as to the customer's risk level.

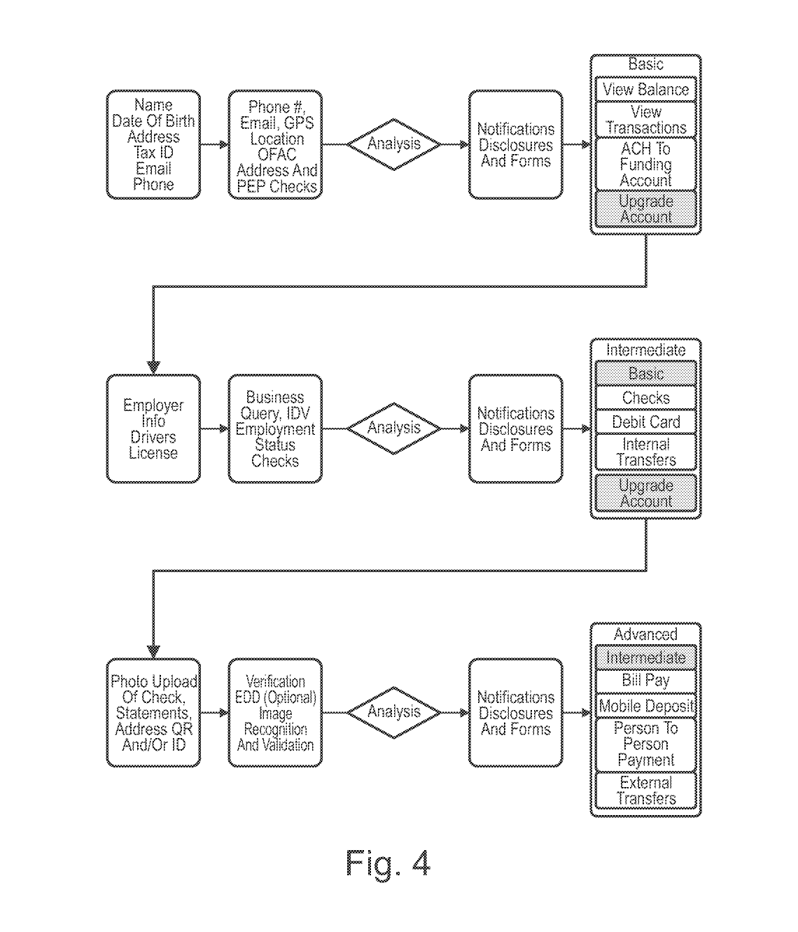

The recommendation engine 206 utilizes information from the verification analysis 204 and the provider risk model 205 to make recommendations concerning whether a customer should be permitted to open an account, and if so, what types of accounts should be offered to the customer and what restrictions should be imposed. In one embodiment, the recommendation engine 206 can be implemented as a feature-driven model based on a set of logical rules provided by the risk model 205. Example recommendations include: (1) recommending that a new account request be denied if the customer fails the U.S. OFAC screening; or (2) recommending that a customer be permitted to open a deposit account with the intermediate risk features shown in FIG. 4 if the customer's identification can be authenticated using IDV but the customer is classified as medium risk because of the due diligence analyses. Any number of rules and suitable features known those skilled in the art can be used to implement the recommendation engine 206.

The recommendation engine 206 can also recommend alternative courses of action in the event a new account request is denied. So, for instance, if a customer requesting a brokerage trading account is classified as a high risk, the recommendation engine 206 could provide one or more suggested courses of action, such as: (1) recommend that the provider request additional information from the customer to perform a further verification analysis 204; or (2) recommend that the provider deny the new account request but offer the customer an opportunity to open an account with specific transaction limits. After an account has been opened, the recommendation engine 206 also considers monitoring information from the monitoring engine 210 to determine whether to recommend that account restrictions be lifted.

Information associated with the account opening, system recommendations, and customer notifications are stored in a historical decision and recommendation database 207 on the provider's computer system 100. Historical decision data can be used to continuously monitor a customer's account, as described in more detail below, or to refine the models and techniques used to implement the components of the present invention. In one embodiment, if an analysis of information stored in the historical decision and recommendation database 207 reveals that the geographic location of a business has a lower correlation to instances of fraud than whether the customer accepts foreign electronic funds transfers, then the scoring in the historical account analysis and due diligence models can be adjusted accordingly.

The provider risk model 205 provides rules, model parameters, and other inputs to the recommendation engine 206 to adjust the recommendations so as to accommodate the provider's risk profile. As an example, a provider with a conservative risk profile may deem that any customer whose employment history cannot be verified is deemed a high risk and that such a customer should not be permitted to open an account. Alternatively, the provider risk model 205 can instead classify such a customer as a moderate risk or classify the customer as a high risk but offer the customer an opportunity to open a basic account with the restrictions shown in FIG. 4. These rules and model parameters are input to the recommendation engine 206 for use in evaluating individual customers and new account requests. The provider risk model 205 considers a variety of factors, including, but not limited to: the type of account and services requested by the customer; the type of business entity for business clients; the geographic location of the customer; the expected volume of transactions; prior account history, if any; the nature of the provider's relationship with the customer; and any other relevant information, such as customer information considered in connection with the verification analysis 204.

Once an account is open, the monitoring engine 210 monitors the account and provides inputs to the recommendation engine 206 for use in evaluating possible account upgrades or downgrades, such as making recommendations to lift account restrictions based on positive historical transactions and patterns or to impose additional restrictions if high risk activities are detected. For instance, if the initial verification analysis 204 reveals that a customer is a politically exposed person, the customer might be allowed to open an account but not make electronic funds transfers over a certain dollar amount. If the monitoring engine 210 later determines that the customer is no longer a politically exposed person, the electronic funds transfer restriction can be lifted.

Also shown in FIG. 2 is the notice module 208 that generates notices to customers that the provider is requesting information to verify the customer's identity. Notices generated by the notice module 208 generally include components that relay information about the provider's identification requirements and that present customers with requisite disclosures and forms. The notices optionally include information about the results of the verification analysis 204 or the output of the recommendation engine 206. Preferably, notices are given to the customer before the account is opened or an upgrade request is approved or denied.

Progressive account opening can be better understood with reference to the exemplary embodiment shown in FIG. 4. A customer can quickly and conveniently open an account by providing basic biographical information (e.g., name, date of birth, address, tax identification number, email address, and telephone number). The provider performs a partial verification analysis 204 through phone, email, address, and location verification and through OFAC and PEP screening. Before opening the account, the provider gives adequate notice 208 to the customer that the provider is requesting information to verify the customer's identity.

Based on the limited customer information provided, the recommendation engine 206 recommends that the customer be allowed to open a basic deposit account with restrictions on high and medium risk account features. Specifically, the customer is permitted to view balances and account transactions and to fund the account through an Automated Clearing House (“ACH”) electronic funds transfer. Thus, customer friction is reduced by permitting the customer to quickly and successfully open a deposit account, and the risk to the provider is minimized.

After opening the deposit account, the customer may request an upgrade to the account or the removal of restrictions. Alternatively, the monitoring and recommendation engines 210 & 206 might determine that the customer's positive account history justifies offering an upgrade to the account or the removal of account restrictions. In either case, the provider requests additional information from the customer, such as employment and income history or scanned copies of the customer's driver's license.

The provider also performs an additional verification analysis 204 through business validation techniques and an employment and income verification. Once again, appropriate notice 208 is provided to the customer concerning the request for additional identification information. If results of the further verification analysis 204 indicate that the customer fits a medium risk profile, then the recommendation engine 206 may recommend lifting certain account restrictions and making certain medium risk features available to the customer along with the previously available basic features. Medium risk features include, for example, personal checks, a debit card, and the capability of making electronic funds transfers to internal provider accounts also owned by the customer. The recommendation engine 206 can also recommend additional restrictions, such as implementing a hold of a specific duration on the account funds.

A further upgrade request is initiated by the customer or the monitoring and recommendation engines 210 & 206, and the provider requests additional information from the customer, including a scanned copy of a check, copies of statements from a separate account, address verification information, or additional forms of identification (e.g., a passport). The provider conducts further a verification analysis 204 that includes an enhanced due diligence check or an image recognition analysis using cancellable biometric information on file with the provider or transmitted from the consumer computing device 101.

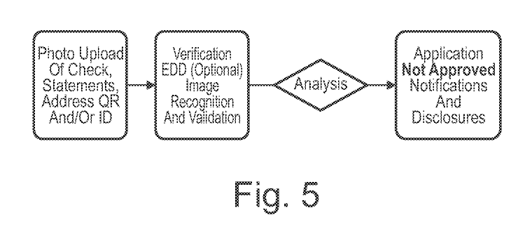

If the further verification analysis 204 is successful, the customer is classified as low risk, and the recommendation engine 206 recommends lifting certain account restrictions and making additional account features available, including automatic bill payment, the ability to make deposits using a mobile consumer computing device 101, person to person payments, and external transfers. Alternatively, if the verification analysis 204 is not successful (e.g., the enhanced due diligence returns a result indicating that the customer is medium or high risk), then the upgrade request is denied, as shown in FIG. 5. In either event, the customer is provided with appropriate notice 208 that additional identifying information was requested.

Although the foregoing description provides embodiments of the invention by way of example, it is envisioned that other embodiments may perform similar functions and/or achieve similar results. Any and all such equivalent embodiments and examples are within the scope of the present invention.

What is claimed is:

1. A computer-implemented method of processing an account application comprising:
(a) providing a computing device associated with a provider;
(b) receiving by the provider computing device, an account application containing customer information and a request selected from the group consisting of a request to open a new account, a request to upgrade an existing account, and a request to downgrade an existing account;
(b) performing a verification analysis;
(c) performing a recommendation analysis; and
(d) generating an application status message indicating an approval or disapproval of the account application.

2. The method of claim 1 wherein:
(a) the account application is transmitted to the provider computing device by a computing device associated with a customer; and
(b) the application status message is transmitted by the provider computing device to the customer computing device.

3. The method of claim 1 wherein:
(a) the account application is transmitted to the provider computing device by a provider terminal computing device; and
(b) the application status message is transmitted by the provider computing device to the provider terminal.

4. The method of claim 1 wherein the verification analysis further comprises screening the customer information against a database of individuals or entities known to present an increased risk to the provider.

5. The method of claim 1 wherein the verification analysis further comprises performing an account ownership verification analysis.

6. The method of claim 1 wherein the verification analysis further comprises performing a historical account analysis.

7. The method of claim 1 wherein the verification analysis further comprises performing a due diligence analysis.

8. A computer-implemented method of processing an account application comprising:
(a) providing a computing device associated with a provider;
(b) monitoring by the provider computing device, customer account activity data associated with a customer account;
(c) performing a historical account analysis utilizing customer account activity data;
(d) creating an account application containing a request to upgrade or downgrade a customer account;
(e) storing the account application to a database in the provider computing device;
(f) performing a recommendation analysis; and
(g) generating an account application status message indicating an approval or disapproval of the account application.

9. The method of claim 8 further comprising the step of performing a verification analysis before performing the recommendation analysis.

10. A system for processing an account application comprising:
a first processor associated with a provider;
a data storage device including a computer-readable medium having computer readable code for instructing the first processor, and when executed by the first processor, the first processor performs operations comprising:
(a) receiving an account application containing customer information and a request selected from the group consisting of a request to open a new account, a request to upgrade an existing account, or a request to downgrade an existing account;
(b) performing a verification analysis;
(c) performing a recommendation analysis; and
(d) generating an application status message indicating an approval or disapproval of the account application.

11. The system of claim 10 further comprising:
a second processor associated with a customer;
a data storage device including a computer-readable medium having computer readable code for instructing the second processor; and
wherein the first processor is further configured to perform the operations of:
(a) receiving the account application transmitted by the second processor; and
(b) transmitting the account application status message to the second processor.

12. The system of claim 10 further comprising:
a second processor associated with a provider terminal computing device;
a data storage device including a computer-readable medium having computer readable code for instructing the second processor; and
wherein the first processor is further configured to perform the operations of:
(a) receiving the account application transmitted by the second processor; and
(b) transmitting the account application status message to the second processor.

13. The system of claim 10 wherein the first processor is further configured to perform as part of the verification analysis, the operation of screening the customer information against a database of individuals or entities known to present an increased risk to the provider.

14. The system of claim 10 wherein the first processor is further configured to perform as part of the verification analysis, an account ownership verification analysis.

15. The system of claim 10 wherein the first processor is further configured to perform as part of the verification analysis, a historical account analysis.

16. The system of claim 10 wherein the first processor is further configured to perform as part of the verification analysis, a due diligence analysis.

17. A system for processing an account application comprising:
a first processor associated with a provider;
a data storage device including a computer-readable medium having computer readable code for instructing the first processor, and when executed by the first processor, the first processor performs operations comprising:
(a) monitoring customer account activity data associated with a customer account;
(b) performing a historical account analysis utilizing customer account activity data;
(c) creating an account application containing a request to upgrade or downgrade a customer account;
(d) storing the account application to a database in the provider computing device;
(e) performing a recommendation analysis; and
(f) generating an account application status message indicating an approval or disapproval of the account application.

18. The system of claim 17 wherein the first processor is further configured to perform a verification analysis before performing the recommendation analysis.
